(19) United States
(12) Patent Application Publication
(10) Pub. No.: US 2025/0237000 A1
(43) Pub. Date: Jul. 24, 2025

(54) METHOD FOR CONTROLLING CLEANER, CONTROL DEVICE FOR CLEANER, AND CLEANER

(71) Applicant: WUXI LITTLE SWAN ELECTRIC CO., LTD., Wuxi, Jiangsu (CN)

(72) Inventor: Zhiwei ZHANG, Wuxi (CN)

(73) Assignee: WUXI LITTLE SWAN ELECTRIC CO., LTD., Wuxi, Jiangsu (CN)

(21) Appl. No.: 18/685,302

(22) PCT Filed: Aug. 31, 2023
(86) PCT No.: PCT/CN2023/116348

§ 371 Date: Feb. 21, 2024

(30) Foreign Application Priority Data
Mar. 30, 2023 (CN) 202310339622.6

(51) Int. Cl. D06F 34/00; A47L 11/40; D06F 58/20; D06F 58/38; D06F 58/44; D06F 105/40

(52) U.S. Cl. CPC D06F 34/00; A47L 11/4011; D06F 58/203; D06F 58/38; D06F 58/44; A47L 2201/028; D06F 2105/40

(57) ABSTRACT

A method for controlling a cleaner, a control device for a cleaner, and a cleaner are provided. The method for controlling the cleaner includes the following operations. A working request of the first apparatus is acquired. A working state of the second apparatus is acquired. It is determined that the working state of the second apparatus and the working request of the first apparatus meet a preset interference condition, at least part of a first functional component corresponding to the working request of the first apparatus is controlled to be in a deactivated state, and/or at least part of a second functional component corresponding to the working state of the second apparatus is controlled to be in a deactivated state.

### CROSS-REFERENCE TO RELATED APPLICATIONS

This application is a National Stage Entry under 35 U.S.C. § 371 of PCT International Application No. PCT/CN2023/116348, filed on Aug. 31, 2023, which claims the priority to Chinese Patent Application No. 202310339622.6, filed on Mar. 30, 2023, and entitled “METHOD FOR CONTROLLING CLEANER, CONTROL DEVICE FOR CLEANER, AND CLEANER”, the entire contents of each of which are incorporated herein by reference.

### FIELD

The disclosure relates to the field of cleaners, and more particularly to a method for controlling a cleaner, a control device for a cleaner, and a cleaner.

### BACKGROUND

With the improvement of people's living standards and the development of production technologies of household appliances, there are more and more cleaners in homes of the people. However, since a space for the placement of the cleaners in the homes is usually limited, two cleaners with the same function or different functions may be integrated together, thereby saving the space.

In the related art, it is possible that a plurality of cleaners may perform work simultaneously. However, if the work performed simultaneously by the two cleaners of the plurality of cleaners interferes with each other, the two cleaners influence each other when they perform the work simultaneously.

### SUMMARY

The Technical Problems to be Solved

The technical problems to be solved by the disclosure are to solve the problems that when a plurality of cleaners perform work simultaneously, the work performed simultaneously by two cleaners of the plurality of cleaners interferes with each other, and the two cleaners influence each other when they perform the work simultaneously.

### Technical Solutions

In order to solve the above technical problems, the disclosure provides a method for controlling a cleaner, a control device for a cleaner, and a cleaner.

In a first aspect, an embodiment of the disclosure provides a method for controlling a cleaner. The cleaner includes a first apparatus and a second apparatus, one of the first apparatus and the second apparatus is a floor cleaner, and another one of the first apparatus and the second apparatus is a laundry treatment apparatus. The method includes the following operations.

A working request of the first apparatus is acquired.

A working state of the second apparatus is acquired.

It is determined that the working state of the second apparatus and the working request of the first apparatus meet a preset interference condition, at least part of a first functional component corresponding to the working request of the first apparatus is controlled to be in a deactivated state, and/or at least part of a second functional component corresponding to the working state of the second apparatus is controlled to be in a deactivated state.

In some embodiments, the first functional component at least includes two components, and the second functional component at least includes two components.

In some embodiments, the first apparatus is the laundry treatment apparatus, and the second apparatus is the floor cleaner. The first functional component at least includes a drying assembly and a steam generating assembly, and the second functional component at least includes a heating assembly for washing water and a pump assembly.

In some embodiments, the operation that it is determined that the working state of the second apparatus and the working request of the first apparatus meet the preset interference condition includes the following operation.

It is determined that a sum of a working power corresponding to the working state of the second apparatus and a working power corresponding to the working request of the first apparatus is greater than a preset power.

In some embodiments, the operation that it is determined that the working state of the second apparatus and the working request of the first apparatus meet the preset interference condition includes the following operation.

It is determined that work corresponding to the working state of the second apparatus and work corresponding to the working request of the first apparatus are preset interference work.

In some embodiments, after the at least part of the first functional component corresponding to the working request of the first apparatus is controlled to be in the deactivated state, the method includes the following operation.

The first apparatus is controlled to perform remaining work in the working request.

Herein, the remaining work is work in the working request except work for operating the at least part of the first functional component.

In some embodiments, after the second functional component corresponding to the working state of the second apparatus is controlled to be in the deactivated state, the method includes the following operation.

The first apparatus is controlled to perform work corresponding to the working request.

In some embodiments, the first apparatus is the floor cleaner, and the second apparatus is the laundry treatment apparatus. The working request of the floor cleaner is a washing operation, and the working state of the laundry treatment apparatus is a drying working state. The first functional component includes a heating assembly for washing water.

The operation that the at least part of the first functional component corresponding to the working request of the first apparatus is controlled to be in the deactivated state includes the following operation. The heating assembly for the washing water is controlled to be in the deactivated state.

In some embodiments, the first apparatus is the floor cleaner, and the second apparatus is the laundry treatment apparatus. The working request of the floor cleaner is a washing operation, and the working state of the laundry treatment apparatus is a drying working state. The second functional component includes a steam generating assembly.

The operation that the at least part of the second functional component corresponding to the working state of the second apparatus is controlled to be in the deactivated state includes the following operation. The steam generating assembly is controlled to be in the deactivated state.

In some embodiments, the second apparatus is the floor cleaner, and the first apparatus is the laundry treatment apparatus.

The working request of the laundry treatment apparatus is a drying operation, and the working state of the floor cleaner is a washing working state. The first functional component includes a steam generating assembly.

The operation that the first functional component corresponding to the working request of the first apparatus is controlled to be in the deactivated state includes the following operation. The steam generating assembly is controlled to be in the deactivated state.

In some embodiments, the second apparatus is the floor cleaner, and the first apparatus is the laundry treatment apparatus.

The working request of the laundry treatment apparatus is a drying operation, and the working state of the floor cleaner is a washing working state. The second functional component includes a heating assembly for washing water.

The operation that the at least part of the second functional component corresponding to the working state of the second apparatus is controlled to be in the deactivated state includes the following operation. The heating assembly for the washing water is controlled to be in the deactivated state.

In a second aspect, an embodiment of the disclosure also provides a control device for a cleaner. The control device for the cleaner includes a first acquisition module, a second acquisition module, and a control module.

The first acquisition module is configured to acquire a working request of a first apparatus.

The second acquisition module is configured to acquire a working state of a second apparatus.

The control module is configured to determine that the working state of the second apparatus and the working request of the first apparatus meet a preset interference condition, control at least part of a first functional component corresponding to the working request of the first apparatus to be in a deactivated state, and/or control at least part of a second functional component corresponding to the working state of the second apparatus to be in a deactivated state.

In a third aspect, an embodiment of the disclosure also provides a computer-readable storage medium. The computer-readable storage medium has stored thereon programs or instructions that when executed by a computer, perform the operations of the method according to any one of the first aspect.

In a fourth aspect, an embodiment of the disclosure also provides a cleaner. The cleaner includes a processor and a memory, and the processor is configured to call programs or instructions stored in the memory to perform the operations of the method according to any one of the first aspect.

### Beneficial Effects

Compared with the related art, the above technical solutions provided by embodiments of the disclosure have the following advantages.

The disclosure provides a method for controlling a cleaner. The cleaner includes a first apparatus and a second apparatus, one of the first apparatus and the second apparatus is a floor cleaner, and another one of the first apparatus and the second apparatus is a laundry treatment apparatus. The method includes the following operations. A working request of the first apparatus is acquired. A working state of the second apparatus is acquired. It is determined that the working state of the second apparatus and the working request of the first apparatus meet a preset interference condition, at least part of a first functional component corresponding to the working request of the first apparatus is controlled to be in a deactivated state, and/or at least part of a second functional component corresponding to the working state of the second apparatus is controlled to be in a deactivated state. Therefore, the first functional component corresponding to the working request of the first apparatus is controlled to be in the deactivated state to reduce a working power of the first apparatus, and/or the second functional component corresponding to the working state of the second apparatus is controlled to be in the deactivated state to reduce a working power of the second apparatus. In this way, the first apparatus and the second apparatus may perform work simultaneously, to improve the cleaning efficiency of the cleaner, and the problems that the work performed simultaneously by the first apparatus and the second apparatus interferes with each other, and the first apparatus and the second apparatus influence each other when they perform the work simultaneously may be avoided.

It should be understood that the above general description and the following detailed description are only exemplary and explanatory, and are not intended to limit the disclosure.

### BRIEF DESCRIPTION OF THE DRAWINGS

The drawings which are incorporated in the description and constitute a part of the description illustrate embodiments of the disclosure, and explain the principle of the disclosure together with the description.

In order to more clearly illustrate the technical solution in the embodiments of the disclosure or in the related art, the drawings required to be used in the description of the embodiments or the related art will be briefly described below. It will be apparent that those skilled in the art may obtain other drawings according to these drawings without creative labor.

FIG. 1 is a schematic flowchart of a method for controlling a cleaner according to an embodiment of the disclosure.

FIG. 2 is a front view of a cleaner according to an embodiment of the disclosure.

FIG. 3 is a detailed schematic flowchart of a method for controlling a cleaner according to an embodiment of the disclosure.

FIG. 4 is a detailed schematic flowchart of another method for controlling a cleaner according to an embodiment of the disclosure.

FIG. 5 is a schematic diagram of a control device for a cleaner according to an embodiment of the disclosure.

FIG. 6 is a schematic diagram of a cleaner according to an embodiment of the disclosure.

### DETAILED DESCRIPTION

In order to make objectives, technical solutions and advantages of embodiments of the disclosure more articulated, the technical solutions in the embodiments of the disclosure will be clearly and completely described below. It will be apparent that the described embodiments are part of, but not all of, the embodiments of the disclosure. Based on the embodiments in the disclosure, all other embodiments obtained by ordinary skill in the art without creative labor fall within the scope of protection of the disclosure.

In the related art, it is possible that two cleaners with the same function or different work in integrated form may perform work simultaneously. If the work performed simultaneously by the two cleaners interferes with each other, the two cleaners influence each other when they perform the work simultaneously.

In order to solve the above problems, an embodiment of the disclosure provides a method for controlling a cleaner. The method for controlling the cleaner may be performed by a first apparatus, which is configured to acquire a working request of the first apparatus and acquire a working state of a second apparatus. The method for controlling the cleaner may be performed by the second apparatus, which is configured to acquire the working request of the first apparatus and acquire the working state of the second apparatus. The method for controlling the cleaner may also be performed by a control device, such as an intelligent terminal, which is independent of the first apparatus and the second apparatus. The intelligent terminal is configured to acquire the working request of the first apparatus and acquire the working state of the second apparatus.

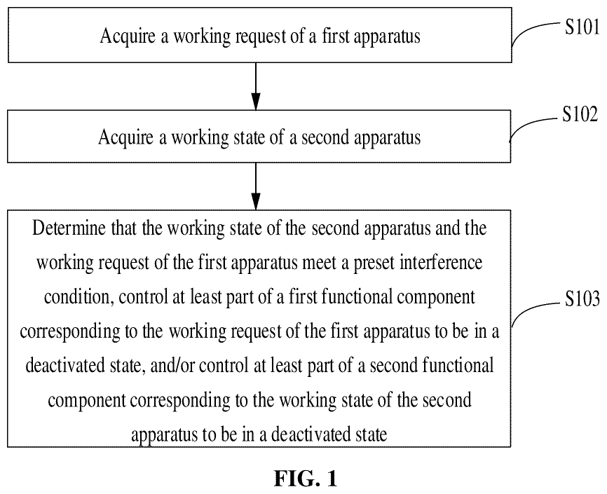

FIG. 1 is a schematic flowchart of a method for controlling a cleaner according to an embodiment of the disclosure. As shown in FIG. 1, the method includes the following operations.

At S101, a working request of a first apparatus is acquired.

Herein, the cleaner includes the first apparatus and a second apparatus, one of the first apparatus and the second apparatus is a floor cleaner, and another one of the first apparatus and the second apparatus is a laundry treatment apparatus.

In an embodiment, when the first apparatus needs to perform work, the working request of the first apparatus may, for example, be sent by the first apparatus or by an intelligent terminal in communication with the first apparatus. An apparatus for sending the working request of the first apparatus is not limited in the embodiment of the disclosure.

At S102, a working state of the second apparatus is acquired.

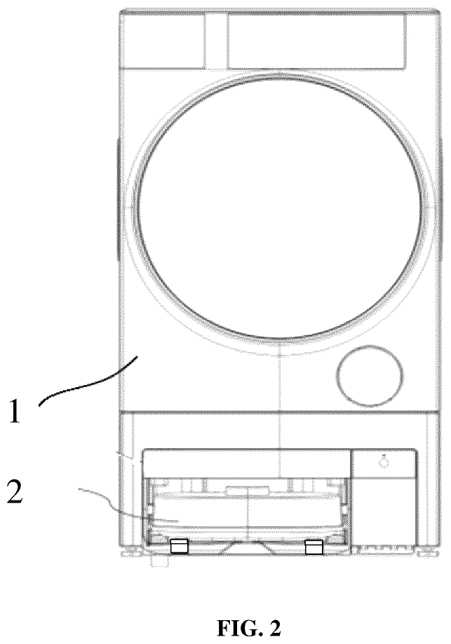

In an embodiment, FIG. 2 is a front view of a cleaner according to an embodiment of the disclosure. FIG. 2 exemplarily shows that one of the first apparatus and the second apparatus is a floor cleaner 2, and another one of the first apparatus and the second apparatus is a laundry treatment apparatus 1. The floor cleaner 2 is arranged below the laundry treatment apparatus 1, and a space below the laundry treatment apparatus 1 provides a floor space for the floor cleaner 2, to prevent the floor cleaner 2 from occupying an additional space. In addition, the first apparatus and the second apparatus may be independently and separately arranged. The embodiment of the disclosure is not limited thereto.

Exemplarily, each of the first apparatus and the second apparatus is an apparatus with cleaning requirements. The first apparatus may, for example, be provided as a floor cleaner, and the second apparatus may, for example, be provided as a laundry treatment apparatus. Alternatively, the first apparatus may, for example, be provided as a laundry treatment apparatus, and the second apparatus may, for example, be provided as a floor cleaner. The embodiment of the disclosure is not limited thereto. When the second apparatus is performing work, the working state of the second apparatus may, for example, be sent by the second apparatus or by an intelligent terminal in communication with the second apparatus. An apparatus for sending the working state of the second apparatus is not limited in the embodiment of the disclosure.

At S103, it is determined that the working state of the second apparatus and the working request of the first apparatus meet a preset interference condition, at least part of a first functional component corresponding to the working request of the first apparatus is controlled to be in a deactivated state, and/or at least part of a second functional component corresponding to the working state of the second apparatus is controlled to be in a deactivated state.

In some embodiments, if the first apparatus needs to perform work, the working state of the second apparatus may be acquired, and it is determined whether the working state of the second apparatus and the working request of the first apparatus meet the preset interference condition. Exemplarily, the first apparatus is provided as the floor cleaner, and the second apparatus is provided as the laundry treatment apparatus. After the floor cleaner cleans floor, a cleaning element of the floor cleaner becomes dirty, and the floor cleaner returns to a base station to allow the cleaning element of the floor cleaner to be washed. If the cleaning element of the floor cleaner needs to be washed while the laundry treatment apparatus is performing drying work, an electrical power in homes may not meet the requirements for the laundry treatment apparatus to perform the drying work and the base station to perform washing work simultaneously, and the floor cleaner and the laundry treatment apparatus cannot perform work simultaneously. Therefore, the washing work of the floor cleaner and the drying work of the laundry treatment apparatus are provided as interference work, and the working state of the second apparatus and the working request of the first apparatus meet the preset interference condition.

Exemplarily, the first apparatus is for example the floor cleaner. When the floor cleaner returns to the base station to allow the cleaning element to be washed, a plurality of functional components, such as a pump assembly and a heating assembly for washing water, need to be activated to realize the washing of the cleaning element. Herein, for example, the heating assembly for the washing water is configured to heat the washing water to improve the washing efficiency and the washing effect of the cleaning element, and the pump assembly is configured to drive the cleaning element to rotate to realize the washing. In the embodiment of the disclosure, each of the components that enable the cleaning element of the floor cleaner to be washed, such as the heating assembly for the washing water and the pump assembly, may be provided as the first functional component corresponding to a washing working request of the floor cleaner.

Exemplarily, the second apparatus is for example the laundry treatment apparatus. When the laundry treatment apparatus performs the drying work of laundries, a plurality of functional components, such as a drying assembly and a steam generating assembly, need to be activated to realize the drying of the laundries. Herein, the drying assembly is configured to dry the laundries, and the steam generating assembly is configured to iron the laundries after generating steam, to avoid the appearance of wrinkles of the dried laundries. In the embodiment of the disclosure, each of the components that enable the laundry treatment apparatus to dry the laundries, such as the steam generating assembly and the drying assembly, may be provided as the second functional component corresponding to a drying working state of the laundry treatment apparatus.

In order to solve the problems that work corresponding to the working state of the laundry treatment apparatus and work corresponding to the working request of the floor cleaner are the interference work, and the floor cleaner and the laundry treatment apparatus cannot perform work simultaneously, the following operations may be performed. The heating assembly for the washing water of the floor cleaner may be in the deactivated state to reduce a working power of the floor cleaner, and only the cleaning element of the floor cleaner may be washed with room temperature water. For example, the steam generating assembly of the laundry treatment apparatus may also be deactivated to reduce a working power of the laundry treatment apparatus, and the laundry treatment apparatus may perform drying work except ironing work of the steam generating assembly. In addition, the heating assembly for the washing water of the floor cleaner and the steam generating assembly of the laundry treatment apparatus may also be controlled to be in the deactivated state, to reduce the working power of the floor cleaner and the working power of the laundry treatment apparatus.

Therefore, in the embodiment of the disclosure, the at least part of the first functional component corresponding to the working request of the first apparatus is controlled to be in the deactivated state to reduce the working power of the first apparatus, and/or the at least part of the second functional component corresponding to the working state of the second apparatus is controlled to be in the deactivated state to reduce the working power of the second apparatus. In this way, the first apparatus and the second apparatus may perform the work simultaneously, to improve the cleaning efficiency of the cleaner, and the problems that the work performed simultaneously by the first apparatus and the second apparatus interferes with each other, and the first apparatus and the second apparatus influence each other when they perform the work simultaneously may be avoided.

In some embodiments, the first functional component at least includes two components, and the second functional component at least includes two components.

Exemplarily, the first apparatus is for example the laundry treatment apparatus, and the second apparatus is for example the floor cleaner. For example, when the laundry treatment apparatus needs to dry the laundries, not only the drying function may be realized, but also the function such as the ironing function may be realized. When the laundries are dried, a plurality of components corresponding to the different functions need to be activated in order to realize the different functions. Therefore, for example, the first functional component at least may include two components.

When the cleaning element of the floor cleaner is washed, the cleaning element may be rotated to realize the washing of the cleaning element, and the washing water may also be heated to improve the washing efficiency and the washing effect. When the cleaning element is washed, a plurality of components corresponding to different functions need to be activated in order to realize the different functions. Therefore, for example, the second functional component at least may include two components.

In some embodiments, the first apparatus is the laundry treatment apparatus, and the second apparatus is the floor cleaner. The first functional component at least includes a drying assembly and a steam generating assembly, and the second functional component at least includes a heating assembly for washing water and a pump assembly.

Exemplarily, the first apparatus is for example the laundry treatment apparatus, and the second apparatus is for example the floor cleaner. For example, when the laundry treatment apparatus needs to dry the laundries, it is necessary to dry the laundries by the drying assembly. In addition to the drying function, when the laundries are dried, it is also possible to iron the laundries by the steam generating assembly. Therefore, for example, the first functional component at least includes the drying assembly and the steam generating assembly. It should be noted that gas generated by the steam generating assembly may, for example, be steam generated by heating or spray generated by ultrasound. The embodiment of the disclosure is not limited thereto.

For example, when the cleaning element of the floor cleaner needs to be washed, it is necessary to drive the cleaning element to rotate by the pump assembly to realize the washing of the cleaning element. In addition, it is also possible to heat the washing water by the heating assembly for the washing water to improve the washing effect and the washing efficiency of the cleaning element. Therefore, for example, the second functional component at least includes the pump assembly and the heating assembly for the washing water.

In some embodiments, the operation that it is determined that the working state of the second apparatus and the working request of the first apparatus meet the preset interference condition includes the following operation.

It is determined that a sum of a working power corresponding to the working state of the second apparatus and a working power corresponding to the working request of the first apparatus is greater than a preset power.

In an embodiment, when the sum of the working power corresponding to the working request of the first apparatus and the working power corresponding to the working state of the second apparatus is too large and greater than the preset power, if the first apparatus and the second apparatus perform the work simultaneously, a socket for supplying power to the first apparatus and the second apparatus may not meet the requirements for the working power of the first apparatus and the working power of the second apparatus. In this way, the working efficiency of the cleaner is reduced. Therefore, when the sum of the working power corresponding to the working request of the first apparatus and the working power corresponding to the working state of the second apparatus is greater than the preset power, the at least part of the first functional component corresponding to the working request of the first apparatus is controlled to be in the deactivated state, and/or the at least part of the second functional component corresponding to the working state of the second apparatus is controlled to be in the deactivated state. In this way, the working power of the first apparatus and/or the working power of the second apparatus is/are reduced, and the problem that the first apparatus and the second apparatus interfere with each other when they perform the work simultaneously is avoided.

In some embodiments, the operation that it is determined that the working state of the second apparatus and the working request of the first apparatus meet the preset interference condition includes the following operation.

It is determined that work corresponding to the working state of the second apparatus and work corresponding to the working request of the first apparatus are preset interference work.

Exemplarily, the first apparatus is for example the floor cleaner, and the second apparatus is for example the laundry treatment apparatus. The laundry treatment apparatus is configured to perform a plurality of work, such as soaking work, washing work, rinsing work and drying work, and the floor cleaner is also configured to perform a plurality of work, such as floor cleaning work, washing work and charging work. The washing work of the floor cleaner and the drying work of the laundry treatment apparatus may be pre-set as the preset interference work. When the work corresponding to the working state of the laundry treatment apparatus is the drying work and the work corresponding to the working request of the floor cleaner is the washing work, it is determined that the working state of the second apparatus and the working request of the first apparatus meet the preset interference condition.

In some embodiments, after the first functional component corresponding to the working request of the first apparatus is controlled to be in the deactivated state, the method includes the following operation.

The first apparatus is controlled to perform remaining work in the working request.

Herein, the remaining work is work in the working request except work for operating the first functional component.

Exemplarily, the first apparatus is for example the floor cleaner, and the second apparatus is for example the laundry treatment apparatus. When the cleaning element of the floor cleaner needs to be washed, the first functional component in the floor cleaner is for example the heating assembly for the washing water. When the sum of the working power corresponding to the working state of the laundry treatment apparatus and the working power corresponding to the working request of the floor cleaner is greater than the preset power, the heating assembly for the washing water may be controlled to be deactivated to reduce the working power of the floor cleaner, and the base station is controlled to wash the cleaning element with the room temperature water to realize the washing of the cleaning element. Therefore, the laundry treatment apparatus and the floor cleaner may perform the work simultaneously without affecting the normal washing of the cleaning element of the floor cleaner. In this way, the problem that the cleaning efficiency of the cleaner is reduced after the floor cleaner or the laundry treatment apparatus is deactivated is avoided, and the cleaning efficiency of the cleaner is improved.

In some embodiments, after the second functional component corresponding to the working state of the second apparatus is controlled to be in the deactivated state, the method includes the following operation.

The first apparatus is controlled to perform work corresponding to the working request.

In an embodiment, the first apparatus is for example the floor cleaner, and the second apparatus is for example the laundry treatment apparatus. For example, the laundry treatment apparatus is performing the drying work, and the second functional component such as the steam generating assembly is activated to iron the laundries, at this time the cleaning element of the floor cleaner needs to be washed. When the sum of the working power of the washing work of the floor cleaner and the working power of the drying work of the laundry treatment apparatus is greater than the preset power, in order to enable the floor cleaner and the laundry treatment apparatus to perform the work simultaneously, the steam generating assembly of the laundry treatment apparatus may be controlled to be deactivated to reduce the working power of the laundry treatment apparatus, the laundry treatment apparatus performs work except work for ironing the wrinkles, and the floor cleaner is controlled to perform the washing work of the cleaning element. Therefore, the floor cleaner and the laundry treatment apparatus may perform the work simultaneously without affecting the drying effect of the laundries by the laundry treatment apparatus and the washing effect of the cleaning element of the floor cleaner. In this way, the cleaning efficiency of the cleaner is improved.

In some embodiments, the first apparatus is the floor cleaner, and the second apparatus is the laundry treatment apparatus. The working request of the floor cleaner is a washing operation, and the working state of the laundry treatment apparatus is a drying working state. The first functional component includes a heating assembly for washing water.

The operation that the at least part of the first functional component corresponding to the working request of the first apparatus is controlled to be in the deactivated state includes the following operation. The heating assembly for the washing water is controlled to be in the deactivated state.

Exemplarily, the first apparatus is for example the floor cleaner, and the second apparatus is for example the laundry treatment apparatus. After the floor cleaner cleans floor, the cleaning element of the floor cleaner becomes dirty. When the floor cleaner returns to the base station to allow the cleaning element to be washed, since the sum of the working power corresponding to the working request of the floor cleaner and the working power corresponding to the working state of the laundry treatment apparatus is greater than the preset power, the socket for supplying the power to the floor cleaner and the laundry treatment apparatus may not meet the requirements for the floor cleaner to perform the washing operation and the laundry treatment apparatus to perform the drying work simultaneously. Therefore, the heating assembly for the washing water of the floor cleaner may be controlled to be deactivated, that is, the washing water is not heated, and the cleaning element of the floor cleaner is washed with the room temperature water. Therefore, the working power of the floor cleaner is reduced, and the sum of the working power of the laundry treatment apparatus and the working power of the floor cleaner is less than or equal to the preset power without affecting the washing effect of the floor cleaner. In this way, the floor cleaner and the laundry treatment apparatus may perform the work simultaneously, to ensure the electricity safety and improve the cleaning efficiency of the cleaner.

It should be noted that, when the heating assembly for the washing water is controlled to be in the deactivated state, the second functional component of the laundry treatment apparatus may be in the deactivated state or in an activated state, which may be set according to an actual use power of the cleaner. The embodiment of the disclosure is not limited thereto.

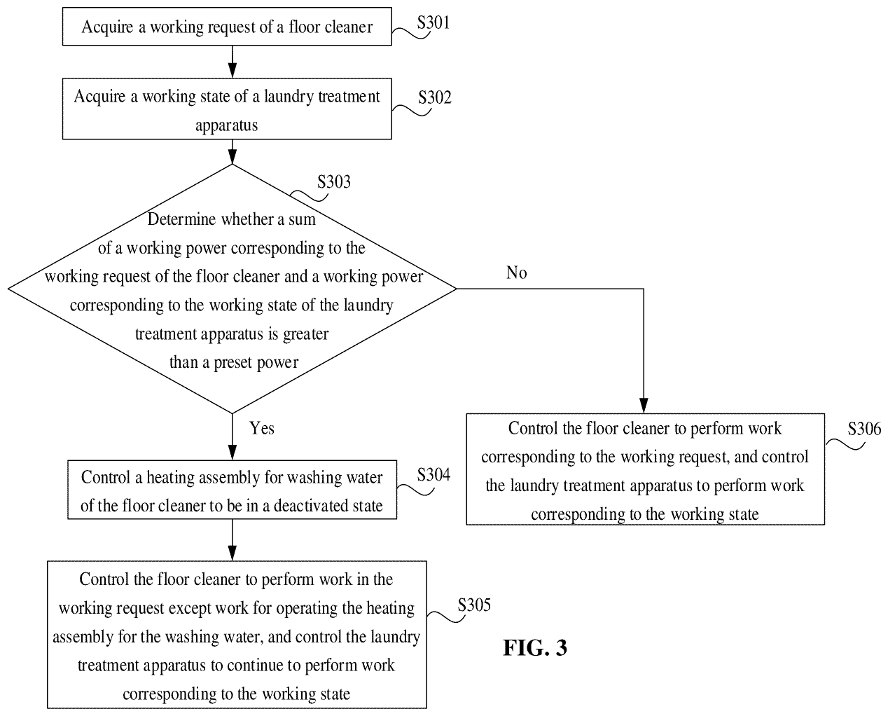

FIG. 3 is a detailed schematic flowchart of a method for controlling a cleaner according to an embodiment of the disclosure. As shown in FIG. 3, the method includes the following operations.

At S301: a working request of a floor cleaner is acquired.

At S302, a working state of a laundry treatment apparatus is acquired.

At S303, it is determined whether a sum of a working power corresponding to the working request of the floor cleaner and a working power corresponding to the working state of the laundry treatment apparatus is greater than a preset power. If the sum of the working power corresponding to the working request of the floor cleaner and the working power corresponding to the working state of the laundry treatment apparatus is greater than the preset power, S304 is performed. If the sum of the working power corresponding to the working request of the floor cleaner and the working power corresponding to the working state of the laundry treatment apparatus is less than or equal to the preset power, S306 is performed.

At S304, a heating assembly for washing water of the floor cleaner is controlled to be in a deactivated state.

At S305, the floor cleaner is controlled to perform work in the working request except work for operating the heating assembly for the washing water, and the laundry treatment apparatus is controlled to continue to perform work corresponding to the working state.

At S306, the floor cleaner is controlled to perform work corresponding to the working request, and the laundry treatment apparatus is controlled to perform work corresponding to the working state.

In some embodiments, a first apparatus is the floor cleaner, and a second apparatus is the laundry treatment apparatus. The working request of the floor cleaner is a washing operation, and the working state of the laundry treatment apparatus is a drying working state. A second functional component includes a steam generating assembly.

The operation that at least part of the second functional component corresponding to the working state of the second apparatus is controlled to be in the deactivated state includes the following operation. The steam generating assembly is controlled to be in the deactivated state.

Exemplarily, the first apparatus is for example the floor cleaner, and the second apparatus is for example the laundry treatment apparatus. When a cleaning element of the floor cleaner needs to be washed, since the sum of the working power corresponding to the washing operation of the floor cleaner and the working power corresponding to the drying working state of the laundry treatment apparatus is greater than the preset power, a socket for supplying power to the floor cleaner and the laundry treatment apparatus may not meet the requirements for the floor cleaner to perform the washing operation and the laundry treatment apparatus to perform drying work simultaneously. The steam generating assembly of the laundry treatment apparatus may be controlled to be in the deactivated state, and the laundry treatment apparatus performs drying work except ironing work. Therefore, the working power of the laundry treatment apparatus is reduced, and the sum of the working power of the laundry treatment apparatus and the working power of the floor cleaner is less than or equal to the preset power without affecting the drying effect of laundries, to ensure the electricity safety. The floor cleaner may perform the washing operation when the laundry treatment apparatus performs the drying work, to improve the cleaning efficiency of the cleaner.

It should be noted that, when the steam generating assembly is controlled to be in the deactivated state, the heating assembly for the washing water of the floor cleaner may be in the deactivated state or in an activated state, which may be set according to an actual use power of the cleaner. The embodiment of the disclosure is not limited thereto.

In some embodiments, the second apparatus is the floor cleaner, and the first apparatus is the laundry treatment apparatus.

A working request of the laundry treatment apparatus is a drying operation, and a working state of the floor cleaner is a washing working state. A first functional component includes the steam generating assembly.

The operation that the first functional component corresponding to the working request of the first apparatus is controlled to be in the deactivated state includes the following operation. The steam generating assembly is controlled to be in the deactivated state.

Exemplarily, the first apparatus is for example the laundry treatment apparatus, and the second apparatus is for example the floor cleaner. When the cleaning element of the floor cleaner is being washed, the laundry treatment apparatus needs to dry the laundries. In order to continue to enable the cleaning element of the floor cleaner to be washed, the steam generating assembly of the laundry treatment apparatus may be kept in the deactivated state, and the laundry treatment apparatus may be controlled to perform drying work except work for operating the steam generating assembly. For example, when the laundries are dried, the laundries are not ironed, and only moisture on the laundries is removed. Therefore, by controlling the steam generating assembly to be in the deactivated state, the working power of the laundry treatment apparatus is reduced, and the sum of the working power of the laundry treatment apparatus and the working power of the floor cleaner is less than or equal to the preset power without affecting the drying effect of the laundry treatment apparatus, to ensure the electricity safety. The laundry treatment apparatus may perform the drying operation when the floor cleaner performs the washing operation, to improve the cleaning efficiency of the cleaner.

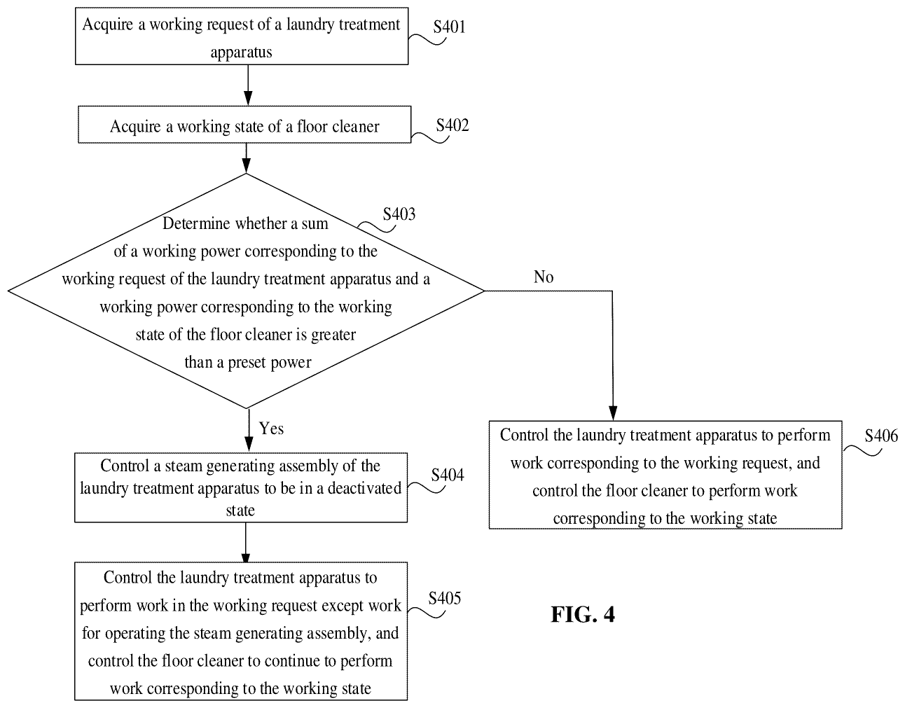

FIG. 4 is a detailed schematic flowchart of another method for controlling a cleaner according to an embodiment of the disclosure. As shown in FIG. 4, the method includes the following operations.

At S401: a working request of a laundry treatment apparatus is acquired.

At S402, a working state of a floor cleaner is acquired.

At S403, it is determined whether a sum of a working power corresponding to the working request of the laundry treatment apparatus and a working power corresponding to the working state of the floor cleaner is greater than a preset power. If the sum of the working power corresponding to the working request of the laundry treatment apparatus and the working power corresponding to the working state of the floor cleaner is greater than the preset power, S404 is performed. If the sum of the working power corresponding to the working request of the laundry treatment apparatus and the working power corresponding to the working state of the floor cleaner is less than or equal to the preset power, S406 is performed.

At S404, a steam generating assembly of the laundry treatment apparatus is controlled to be in a deactivated state.

At S405, the laundry treatment apparatus is controlled to perform work in the working request except work for operating the steam generating assembly, and the floor cleaner is controlled to continue to perform work corresponding to the working state.

At S406, the laundry treatment apparatus is controlled to perform work corresponding to the working request, and the floor cleaner is controlled to perform work corresponding to the working state.

In some embodiments, a second apparatus is the floor cleaner, and a first apparatus is the laundry treatment apparatus.

The working request of the laundry treatment apparatus is a drying operation, and the working state of the floor cleaner is a washing working state. A second functional component includes a heating assembly for washing water.

The operation that at least part of the second functional component corresponding to the working state of the second apparatus is controlled to be in the deactivated state includes the following operation. The heating assembly for the washing water is controlled to be in the deactivated state.

Exemplarily, the first apparatus is for example the laundry treatment apparatus, and the second apparatus is for example the floor cleaner. When a cleaning element of the floor cleaner is being washed, the laundry treatment apparatus needs to dry laundries. Since the sum of the working power corresponding to washing work of the floor cleaner and the working power corresponding to the drying operation of the laundry treatment apparatus is greater than the preset power, in order to continue to enable the cleaning element of the floor cleaner to be washed without being affected by the working request of the laundry treatment apparatus, the heating assembly for the washing water of the floor cleaner may be controlled to be deactivated, and only the cleaning clement is washed with room temperature water. The working power of the floor cleaner is reduced, and the sum of the working power of the laundry treatment apparatus and the working power of the floor cleaner is less than or equal to the preset power without affecting the washing of the cleaning element of the floor cleaner, to ensure the electricity safety. The laundry treatment apparatus may perform the drying operation when the floor cleaner performs a washing operation, to improve the cleaning efficiency of the cleaner, and avoid the problem that the laundry treatment apparatus performs drying work after the washing operation of the floor cleaner is ended which affects the user experience.

In the embodiment of the disclosure, the first functional component corresponding to the working request of the first apparatus is controlled to be in the deactivated state to reduce the working power of the first apparatus, and/or the second functional component corresponding to the working state of the second apparatus is controlled to be in the deactivated state to reduce the working power of the second apparatus. In this way, the first apparatus and the second apparatus may perform the work simultaneously, to improve the cleaning efficiency of the cleaner, and avoid the problems that the work performed simultaneously by the first apparatus and the second apparatus interferes with each other, and the first apparatus and the second apparatus influence each other when they perform the work simultaneously.

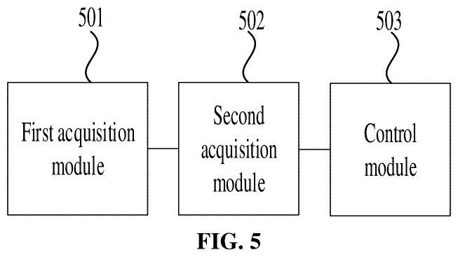

An embodiment of the disclosure also provides a control device for a cleaner. FIG. 5 is a schematic diagram of a control device for a cleaner according to an embodiment of the disclosure. As shown in FIG. 5, the control device for the cleaner includes a first acquisition module 501, a second acquisition module 502 and a control module 503. The first acquisition module 501 is configured to acquire a working request of a first apparatus. The second acquisition module 502 is configured to acquire a working state of a second apparatus. The control module 503 is configured to determine that the working state of the second apparatus and the working request of the first apparatus meet a preset interference condition, control at least part of a first functional component corresponding to the working request of the first apparatus to be in a deactivated state, and/or control at least part of a second functional component corresponding to the working state of the second apparatus to be in a deactivated state.

The device according to the embodiment of the disclosure and the method according to the embodiment of the disclosure have the same inventive concept and have the same beneficial effects, which will not be repeated herein.

An embodiment of the disclosure also provides a computer-readable storage medium. The computer-readable storage medium has stored thereon programs or instructions that when executed by a computer, perform the operations of the method according to any one of the above embodiments.

In some embodiments, computer-executable instructions, when executed by a computer processor, may also perform the technical solutions of the method according to any one of the above embodiments of the disclosure, to realize corresponding beneficial effects.

From the description of above embodiments, it will be apparent to those skilled in the art that the disclosure may be implemented by means of software and necessary general purpose hardware, and of course by means of hardware. However, in many cases, the disclosure may be implemented by means of the software and the necessary general hardware, which is a preferred implementation. Based on such an understanding, the technical solutions of the disclosure in essence or parts of the technical solutions of the disclosure which contribute to the related art may be embodied in the form of software product, and the computer software product may be stored in a computer-readable storage medium, such as a floppy disk of a computer, a read only memory (ROM), a random access memory (RAM), a flash memory, a hard disk or an optical disk and the like, including several instructions to enable a computer device (which may be a personal computer, a server or a network device and the like) to perform the method according to any one of various embodiments of the disclosure.

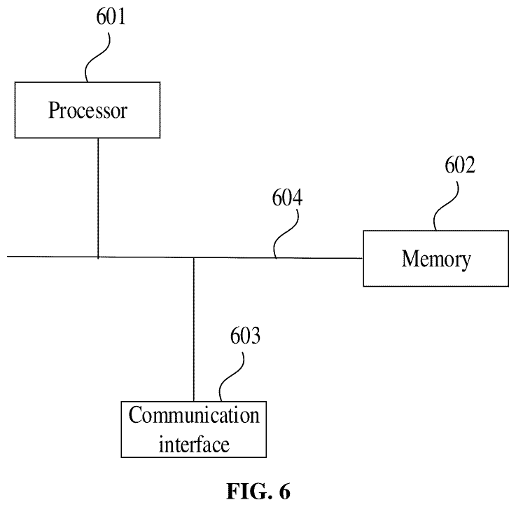

FIG. 6 is a schematic diagram of a cleaner according to an embodiment of the disclosure. As shown in FIG. 6, the cleaner includes a processor 601 and a memory 602, and the processor 601 is configured to call programs or instructions stored in the memory 602 to perform the operations of the method according to any one of the above various embodiments, to realize the beneficial effects of the above embodiments, which will not be repeated herein.

In an embodiment, as shown in FIG. 6, the cleaner may include at least one processor 601, at least one memory 602 and at least one communication interface 603. Various components in the cleaner are coupled to each other by a bus system 604. The communication interface 603 is configured for information transmission with external devices. It can be understood that the bus system 604 is configured to implement communication among these components. The bus system 604 includes a power bus, a control bus and a status signal bus in addition to a data bus. However, for clarity of illustration, various buses are designated as the bus system 604 in FIG. 6.

It can be understood that the memory 602 in the embodiment may be a volatile memory or a non-volatile memory, or may include a volatile memory and a non-volatile memory. In some embodiments, the memory 602 is configured to store the following elements: an executable unit or a data structure, or a subset thereof, or an extended set operating system and an application program thereof. In embodiment of the disclosure, the processor 601 is configured to call the programs or instructions stored in the memory 602 to perform the operations of the method according to the embodiment of the disclosure.

The method according to the embodiment of the disclosure may be applied to or implemented by the processor 601. The processor 601 may be an integrated circuit chip with signal processing capability. In the implementation process, each operation of the above method may be completed by the instructions in the form of integrated logic circuit of hardware or software in the processor 601. The above processor 601 may be a general purpose processor, a digital signal processor (DSP), an application specific integrated circuit (ASIC), a field programmable gate array (FPGA), or another programmable logic device, a discrete gate or transistor logic device, or a discrete hardware component. The general purpose processor may be a microprocessor, or the processor may be any conventional processor and the like.

The operations of the method according to the embodiment of the disclosure may be directly embodied as being executed by a hardware decoding processor, or by the combination of the hardware and software units in the decoding processor. The software units may be located in a storage medium in the art, such as a random access memory, a flash memory, a read only memory, a programmable read only memory, an electrically erasable programmable memory, a register and the like. The storage medium is located in the memory 602, and the processor 601 is configured to read the information in the memory 602 and execute the operations of the method in combination with the hardware of the processor.

The cleaner may also include an entity component or a plurality of entity components, to generate the instructions according to the processor 601 when performing the method according to the embodiment of disclosure. Different entity components may be provided inside or outside the cleaner, such as a cloud server. Each of the entity components cooperates with the processor 601 and the memory 602, to implement the function of the cleaner in the embodiment.

It should be noted that the relationship terms such as “first”, “second” and the like herein are only used to distinguish one entity or operation from another entity or operation, and do not necessarily require or imply any such actual relationship or order among these entities or operations. Moreover, the terms “including”, “include” or any other variation thereof are intended to encompass non-exclusive inclusion, so that a process, a method, an object or a device that includes a set of elements includes not only those elements but also other elements that are not explicitly listed, or also includes elements inherent to such the process, the method, the object or the device. In the absence of further limitations, an element defined by the phrase “includes a . . . ” does not preclude the existence of another identical element in the process, the method, the object or the device that includes the element.

What described above are only exemplary embodiments of the disclosure to enable those skilled in the art to understand or implement the disclosure. It would be apparent to those skilled in the art that various modifications may be made to these embodiments. The general principle defined herein may be implemented in other embodiments without departing from the spirit or scope of the disclosure. Therefore, the disclosure will not be limited to these embodiments shown herein, but is intended to conform to the widest scope consistent with the principle and novel feature disclosed herein.

### INDUSTRIAL APPLICABILITY

The disclosure provides a method for controlling a cleaner. A working request of the first apparatus is acquired. A working state of the second apparatus is acquired. It is determined that the working state of the second apparatus and the working request of the first apparatus meet a preset interference condition, at least part of a first functional component corresponding to the working request of the first apparatus is controlled to be in a deactivated state, and/or at least part of a second functional component corresponding to the working state of the second apparatus is controlled to be in a deactivated state. Therefore, the first apparatus and the second apparatus may perform work simultaneously, to improve the cleaning efficiency of the cleaner, and avoid the problems that a sum of a working power of the first apparatus and a working power of the second apparatus is too large, and the first apparatus and the second apparatus influence each other when they perform the work simultaneously. Therefore, the disclosure has strong industrial applicability.

1-14. (canceled)

15. An apparatus for controlling a cleaner, wherein the cleaner comprises a first apparatus and a second apparatus, one of the first apparatus and the second apparatus is a floor cleaner, and another one of the first apparatus and the second apparatus is a laundry treatment apparatus, the apparatus comprising one or more processors, wherein the one or more processors are configured to:
acquire a working request of the first apparatus;
acquire a working state of the second apparatus; and
determine that the working state of the second apparatus and the working request of the first apparatus meet a preset interference condition, control at least part of a first functional component corresponding to the working request of the first apparatus to be in a deactivated state, and/or control at least part of a second functional component corresponding to the working state of the second apparatus to be in a deactivated state.

16. The apparatus according to claim 15, wherein:
the first functional component comprises at least two components, and the second functional component comprises at least two components; and
the first apparatus is the laundry treatment apparatus, the second apparatus is the floor cleaner, the first functional component comprises at least a drying assembly and a steam generating assembly, and the second functional component comprises at least a heating assembly for washing water and a pump assembly.

17. The apparatus according to claim 15, wherein for determining that the working state of the second apparatus and the working request of the first apparatus meet the preset interference condition, the one or more processors are further configured to:
determine that a sum of a working power corresponding to the working state of the second apparatus and a working power corresponding to the working request of the first apparatus is greater than a preset power.

18. The apparatus according to claim 15, wherein for determining that the working state of the second apparatus and the working request of the first apparatus meet the preset interference condition, the one or more processors are further configured to:
determine that work corresponding to the working state of the second apparatus and work corresponding to the working request of the first apparatus are preset interference work.

19. The apparatus according to claim 15, wherein after the controlling the at least part of the first functional component corresponding to the working request of the first apparatus to be in the deactivated state, the one or more processors are further configured to:
control the first apparatus to perform remaining work in the working request,
wherein the remaining work is work in the working request except work for operating the at least part of the first functional component.

20. The apparatus according to claim 15, wherein after controlling the at least part of the second functional component corresponding to the working state of the second apparatus to be in the deactivated state, the one or more processors are further configured to:
control the first apparatus to perform work corresponding to the working request.

21. The apparatus according to claim 15, wherein:
the first apparatus is the floor cleaner, the second apparatus is the laundry treatment apparatus, the working request of the floor cleaner is a washing operation, the working state of the laundry treatment apparatus is a drying working state, and the first functional component comprises a heating assembly for washing water; and
for controlling the at least part of the first functional component corresponding to the working request of the first apparatus to be in the deactivated state, the one or more processors are further configured to control the heating assembly for the washing water to be in the deactivated state.

22. The apparatus according to claim 15, wherein:
the first apparatus is the floor cleaner, the second apparatus is the laundry treatment apparatus, the working request of the floor cleaner is a washing operation, the working state of the laundry treatment apparatus is a drying working state, and the second functional component comprises a steam generating assembly; and
for controlling the at least part of the second functional component corresponding to the working state of the second apparatus to be in the deactivated state, the one or more processors are further configured to control the steam generating assembly to be in the deactivated state.

23. The apparatus according to claim 15, wherein:
the second apparatus is the floor cleaner, and the first apparatus is the laundry treatment apparatus;
the working request of the laundry treatment apparatus is a drying operation, the working state of the floor cleaner is a washing working state, and the first functional component comprises a steam generating assembly; and
for controlling the at least part of the first functional component corresponding to the working request of the first apparatus to be in the deactivated state, the one or more processors are further configured to control the steam generating assembly to be in the deactivated state.

24. The apparatus according to claim 15, wherein:
the second apparatus is the floor cleaner, and the first apparatus is the laundry treatment apparatus;
the working request of the laundry treatment apparatus is a drying operation, the working state of the floor cleaner is a washing working state, and the second functional component comprises a heating assembly for washing water; and
for controlling the at least part of the second functional component corresponding to the working state of the second apparatus to be in the deactivated state, the one or more processors are further configured to control the heating assembly for the washing water to be in the deactivated state.

25. A cleaner comprising:
a first apparatus and a second apparatus, one of the first apparatus and the second apparatus is a floor cleaner, and another one of the first apparatus and the second apparatus is a laundry treatment apparatus; and
one or more processors and a memory stored thereon programs or instructions, wherein one or more processors are configured to execute the programs or instructions to:
acquire a working request of the first apparatus;
acquire a working state of the second apparatus; and
determine that the working state of the second apparatus and the working request of the first apparatus meet a preset interference condition, control at least part of a first functional component corresponding to the working request of the first apparatus to be in a deactivated state, and/or control at least part of a second functional component corresponding to the working state of the second apparatus to be in a deactivated state.

26. The cleaner according to claim 25, wherein for determining that the working state of the second apparatus and the working request of the first apparatus meet the preset interference condition, the one or more processors are further configured to:
determine that a sum of a working power corresponding to the working state of the second apparatus and a working power corresponding to the working request of the first apparatus is greater than a preset power.

27. The cleaner according to claim 25, wherein for determining that the working state of the second apparatus and the working request of the first apparatus meet the preset interference condition, the one or more processors are further configured to:
determine that work corresponding to the working state of the second apparatus and work corresponding to the working request of the first apparatus are preset interference work.

28. The cleaner according to claim 25, wherein after the controlling the at least part of the first functional component corresponding to the working request of the first apparatus to be in the deactivated state, the one or more processors are further configured to:
control the first apparatus to perform remaining work in the working request,
wherein the remaining work is work in the working request except work for operating the at least part of the first functional component.

29. The cleaner according to claim 25, wherein after controlling the at least part of the second functional component corresponding to the working state of the second apparatus to be in the deactivated state, the one or more processors are further configured to:
control the first apparatus to perform work corresponding to the working request.

30. The cleaner according to claim 25, wherein:
the first apparatus is the floor cleaner, the second apparatus is the laundry treatment apparatus, the working request of the floor cleaner is a washing operation, the working state of the laundry treatment apparatus is a drying working state, and the first functional component comprises a heating assembly for washing water; and
for controlling the at least part of the first functional component corresponding to the working request of the first apparatus to be in the deactivated state, the one or more processors are further configured to control the heating assembly for the washing water to be in the deactivated state.

31. The cleaner according to claim 25, wherein:
the first apparatus is the floor cleaner, the second apparatus is the laundry treatment apparatus, the working request of the floor cleaner is a washing operation, the working state of the laundry treatment apparatus is a drying working state, and the second functional component comprises a steam generating assembly; and
for controlling the at least part of the second functional component corresponding to the working state of the second apparatus to be in the deactivated state, the one or more processors are further configured to control the steam generating assembly to be in the deactivated state.

32. The cleaner according to claim 25, wherein:
the second apparatus is the floor cleaner, and the first apparatus is the laundry treatment apparatus;
the working request of the laundry treatment apparatus is a drying operation, the working state of the floor cleaner is a washing working state, and the first functional component comprises a steam generating assembly; and
for controlling the at least part of the first functional component corresponding to the working request of the first apparatus to be in the deactivated state, the one or more processors are further configured to control the steam generating assembly to be in the deactivated state.

33. The cleaner according to claim 25, wherein:
the second apparatus is the floor cleaner, and the first apparatus is the laundry treatment apparatus;
the working request of the laundry treatment apparatus is a drying operation, the working state of the floor cleaner is a washing working state, and the second functional component comprises a heating assembly for washing water; and
for controlling the at least part of the second functional component corresponding to the working state of the second apparatus to be in the deactivated state, the one or more processors are further configured to control the heating assembly for the washing water to be in the deactivated state.

34. A computer-readable storage medium having stored thereon programs or instructions that when executed by one or more processors, cause the one or more processors to perform a method for controlling a cleaner, wherein the cleaner comprises a first apparatus and a second apparatus, one of the first apparatus and the second apparatus is a floor cleaner, and another one of the first apparatus and the second apparatus is a laundry treatment apparatus, the method comprising:
acquiring a working request of the first apparatus;
acquiring a working state of the second apparatus; and
determining that the working state of the second apparatus and the working request of the first apparatus meet a preset interference condition, controlling at least part of a first functional component corresponding to the working request of the first apparatus to be in a deactivated state, and/or controlling at least part of a second functional component corresponding to the working state of the second apparatus to be in a deactivated state.
